(19) United States
(12) Patent Application Publication
(10) Pub. No.: US 2007/0096000 A1
(43) Pub. Date: May 3, 2007

(54) Vehicle gauge mounting bracket

(76) Inventor: Todd Westberg, Cherry Valley, IL (US)

Correspondence Address: DICKSTEIN SHAPIRO LLP, 1825 EYE STREET NW, Washington, DC, 20006-5403, US

(21) Appl. No.: 11/589,925

(22) Filed: Oct. 31, 2006

Related U.S. Application Data
(60) Provisional application No. 60/731,265, filed on Oct. 31, 2005.

(51) Int. Cl. A47F 5/00

(52) U.S. Cl. 248/315

(57) ABSTRACT

The present invention includes an apparatus for and a method of mounting a gauge or an instrument in a vehicle using a mounting device. In one embodiment, the mounting device includes a vehicle mounting portion which includes a device mounting surface designed to conform to a vehicle mounting surface, an encircling portion designed to encircle the gauge, and means for securing the gauge within the encircling portion. The present invention also includes a method for securely attaching a gauge to a vehicle including the steps of conforming a device mounting surface of a mounting device to an intended vehicle mounting surface, designing an encircling portion of the mounting device to encircle the gauge, and designing a securing means of the mounting device to secure the gauge within the encircling portion of the mounting device.

### BACKGROUND

The present invention relates generally to gauges and instruments used in vehicular applications such as speedometers, fuel gauges and the like, and, more particularly, to the mounting brackets used in mounting the gauges and instruments in the vehicles in which they are contained.

Gauges with illuminated dials and pointers have been made for many years, for a variety of different applications. One of the largest applications for such gauges is the automotive industry where gauges having illuminated dials and pointers are used in large numbers, and have been in use for many years. Much effort has gone into the development of such gauges that can be efficiently and economically manufactured and that are aesthetically pleasing. Numerous patents have been issued on various designs and constructions for such gauges. Similarly, instruments may be used in vehicles to indicate pressure, temperature, liquid level, rotations per minute (RPM) and various other measurements that are used to monitor the operation of a vehicle.

While limited gauges and instruments come standard in vehicles, many consumers prefer to add additional gauges and/or instruments to their vehicles to enhance the monitoring capability available to them. These gauges and/or instruments may be added for specific applications such as automobile drag racing or street racing or may be added to increase the efficiency of the vehicle by monitoring engine and vehicle characteristics. For each of these devices (standard gauges, standard instruments, “add-on” gauges and “add-on” instruments), the device must be mounted or attached to the vehicle.

### SUMMARY

The invention provides a new and novel way of attaching gauges and/or instruments to a vehicle. These gauges and/or instruments may be attached to the outside of the vehicle or to the inside of the vehicle. The invention provides an adjustable mounting bracket including a vehicle mounting portion, an encircling portion and a securing means which enables the user to mount the gauge as desired.

### BRIEF DESCRIPTION OF THE DRAWINGS

FIG. 1 is a right side perspective view of a first exemplary embodiment of a mounting device for affixing a tubular gauge or instrument in a vehicle;

FIG. 2 is a schematic view showing the range of adjustment of the device of FIG. 1;

FIG. 3 is a left side perspective view of the device of FIG. 1;

FIG. 4 is a front view of the device of FIG. 1;

FIG. 5 is a front view of an exemplary gauge mounted within a second embodiment of a mounting device;

FIG. 6 is a cross-sectional view taken along line VI-VI of FIG. 3; and

FIG. 7 is a view like FIG. 6 illustrating a different orientation of the device.

### DETAILED DESCRIPTION OF PREFERRED EMBODIMENTS

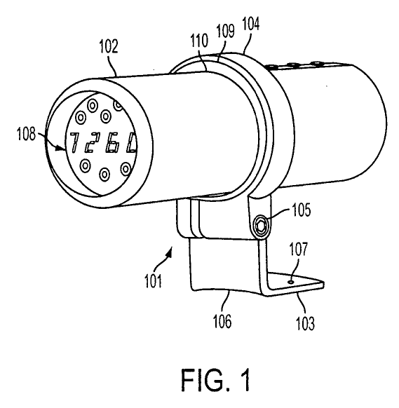

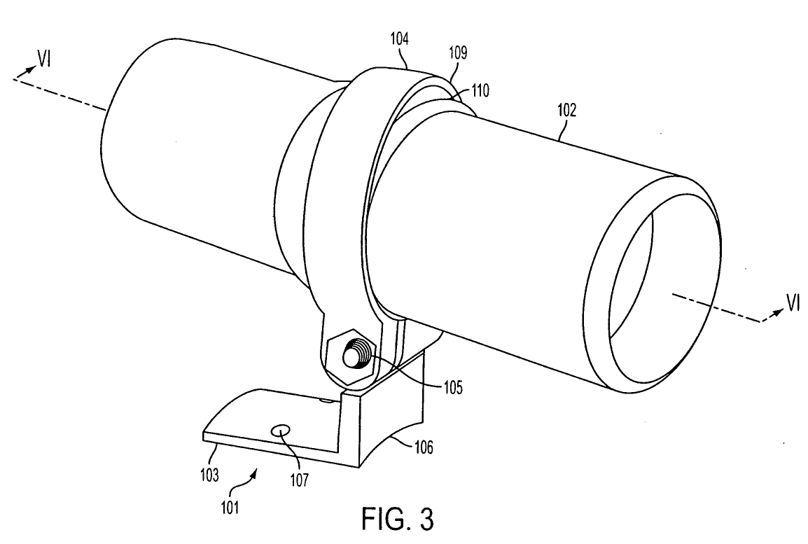

FIGS. 1 and 3, illustrate an exemplary embodiment of a mounting device 101 for affixing a tubular gauge or instrument 102 in a vehicle. As shown, the mounting device 101 includes three portions: a vehicle mounting portion 103, a grasping portion 104, and a securing portion 105.

The vehicle mounting portion 103 includes a device mounting surface 106 which may be curved (as shown) or otherwise contoured to conform to a mounting surface of the vehicle to which mounting device 101 will be attached. As shown, the mounting surface 106 may include one or more holes 107 used to pass bolts (not shown) through to attach the mounting device 101 to the vehicle mounting surface (not shown). Alternatively, other attachment means may be used such as Velcro®, tape, rivets, screws, bolts, brackets, or any other attachment means which affixes the mounting device 101 to the vehicle mounting surface (not shown). While a curved device mounting surface 106 is shown in FIG. 1, one of ordinary skill in the art would appreciate that other shaped device mounting surfaces may be used to conform to, or to give the desired interface with a vehicle mounting surface.

A grasping portion 104 encircles the tubular gauge or instrument 102 such that, when properly fastened, the orientation between the instrument 102 and the mounting device 101 is substantially fixed. In use, at least a portion of the inner surface 109 of the grasping portion 104 makes contact with a portion of the outer circumference 110 of the instrument 102. This capability enables the user to adjust the orientation of the instrument 102 with respect to the mounting device 101. The ability to adjust the orientation of the instrument 102 is desirable to increase the visibility of the gauge face 108 of the instrument 102.

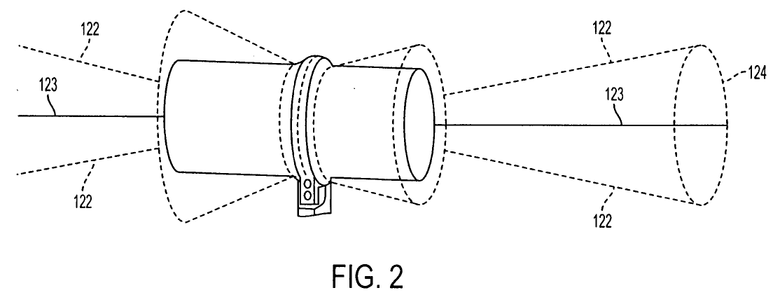

Refer now to FIG. 2 which illustrates the range of movement of the instrument 102 with respect to the device 101. By adjusting the angle of tilt of the instrument 102, the axis 122 of the instrument may be skewed from the axis 123 of the grasping portion 104. Line 124 schematically illustrates the range of possible adjustment angles of the skew of axis 122 to the axis 123. The axis 122 is shown by phantom lines in two skewed positions in FIG. 2 with the instrument 102 shown by phantom lines in two corresponding skewed positions. The range line 124 is defined by the furthermost adjustment extents of the axis 122. Generally the axis 122 thus could be adjusted to anywhere on or inside the line 124. The particular dimensions of the surfaces may be chosen to vary the range of skew 124.

Again referring to FIGS. 1 and 3, the securing portion 105, in this embodiment, may be tightened to reduces the diameter of the encircling grasping portion 104 such that the instrument 102 is securely held by the grasping portion 104.

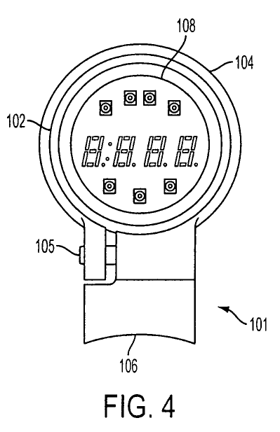

FIG. 4 is a front view of an exemplary instrument 102 mounted within the mounting device of FIG. 1. In this embodiment, the vehicle mounting portion 103 is curved, the grasping portion 104 completely encircles instrument 102 and the securing means 105 is a hex bolt.

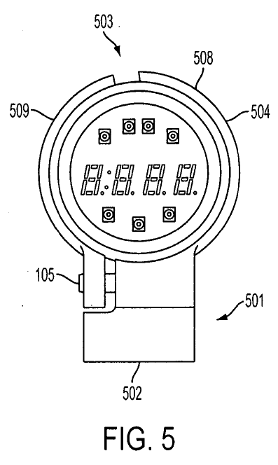

Other methods of securely attaching the 102 to the grasping portion 104 would be understood by one of ordinary skill in the art to be encompassed within the present invention. For example, the grasping portion 104 may be configured so that it does not completely encircle the instrument 102. FIG. 5 is a front view of an exemplary gauge instrument 102 mounted within a second embodiment of a mounting device. In this embodiment, the vehicle mounting portion 502 is flat to conform to a flat vehicle mounting portion, the grasping portion 504 does not completely encircle the gauge 102 in that a gap 503 interrupts a first segment 508 from a second segment 509 of the encircling portion 504. The securing means 105 is a hex bolt engaging with its head the second segment 509 and threaded into the base of the first segment 508.

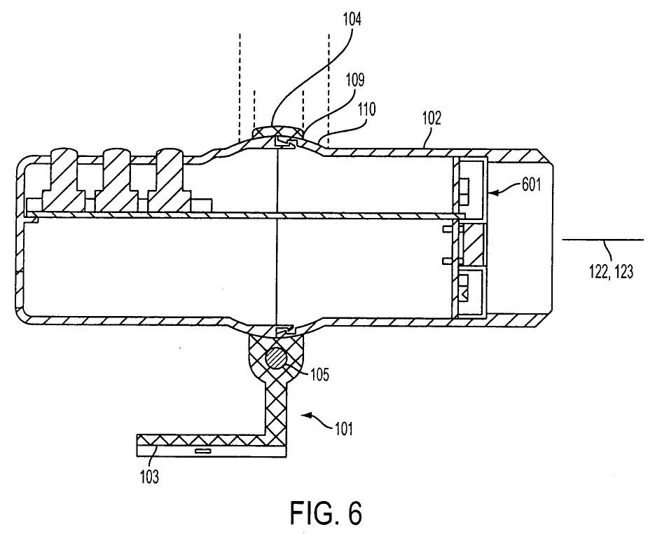

With reference to FIG. 6, the mounting device 101 includes a curved vehicle mounting portion 103, a grasping portion 104, and a securing portion 105. As shown in the cross-sectional view of FIG. 6, in the illustrated embodiment, the inner surface 109 of the grasping portion 104 conforms to the outer raised circumference 110 of the gauge 102. As shown, the inner surface 109 of the grasping portion 109 is a concave surface while the outer circumference 110 of the gauge 102 includes a convex surface. With this configuration the concave surface engages the convex surface to prevent relative movement if the grasping portion 104 and the instrument 122 in the axial direction. The outer circumference 110 of the gauge includes an enlarged raised area 110 which allows the mounting device to 101 to be attached in a way that the orientation of the gauge can be varied. In other words the width of the outer circumferential surface 110 of the gauge (W_{oc} in FIG. 6) is larger than the width of the inner surface 109 (Wᵢₛ in FIG. 6) of grasping portion 104. In this embodiment, the orientation of the gauge is dependent on the portion of the outer circumference 110 of the gauge 102 with which the inner surface 109 of the mounting device 101 mates. In FIG. 6 axis 122 is parallel to axis 123.

The workings of the instrument can be as desired, for example the gauge features as described in Westberg et al., U.S. Pat. No. 5,905,374, entitled “High Performance Tachometer” which was issued on May 18, 1999.

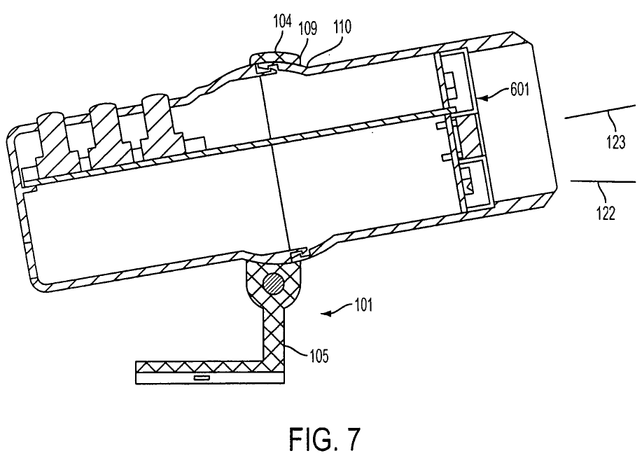

FIG. 7 is a second cross-sectional view illustrating a different orientation possible with mounting device. In this embodiment, the inner surface 109 of the encircling portion 109 mates with a different portion of outer circumference 110 of the gauge 102 allowing the gauge 102 to tilt up. In FIG. 7 axis 122 is skewed from axis 123. Whether parallel or skewed, axis 122 may intersect axis 123.

The foregoing represents some of the possibilities for practicing the invention. Many other embodiments are possible within the scope and spirit of the invention. It is intended that the foregoing description be regarded as illustrative rather than limiting and that the scope of the invention is given by the following claims together with their full range of equivalents.

What is claimed as new and desired to be protected by Letter Patent of the United States is:

1. A mounting device for attaching an instrument to a vehicle comprising:
a vehicle mounting portion including a device mounting surface designed to engage a vehicle mounting surface,
a grasping portion designed to engage said instrument, and
means for securing said instrument within said grasping portion.

2. The mounting device of claim 1 wherein said grasping portion includes an inner surface which engages at least one portion of an outer circumference of said instrument.

3. The mounting device of claim 2 wherein a width of said inner surface of said grasping portion is smaller than the width of said outer circumference of said gauge.

4. The mounting device of claim 3 wherein the smaller width of said inner surface enables the grasping portion to make contact with multiple portions of said outer circumference of said instrument.

5. The mounting device of claim 4 wherein the smaller width of said inner surface is used to vary the orientation of the instrument with respect to said mounting device.

6. The mounting device of claim 1 wherein:
said instrument includes an outer circumference of a first width,
said grasping portion includes an inner surface of a second width wherein said second width is smaller than said first width,
wherein said inner surface contacts said outer circumference when said securing means secures said gauge within said grasping portion.

7. The mounting device of claim 6 wherein a position said contact between said inner surface and said outer circumference and be varied to change the orientation of said instrument.

8. A method for securely attaching a gauge with an outer circumference of a first width to a vehicle comprising the steps of:
conforming a device mounting surface of a mounting device to an intended vehicle mounting surface,
designing an encircling portion of said mounting device to encircle said gauge, wherein said encircling portion includes an inner surface of a second width wherein said inner surface conforms with at least one portion of said outer circumference of said gauge, and
designing a securing means of said mounting device to secure said gauge within said encircling portion of said mounting device.
